(19) United States
(12) Patent Application Publication
(10) Pub. No.: US 2023/0269146 A1
(43) Pub. Date: Aug. 24, 2023

(54) ANY APPLICATION ANY AGENT

(71) Applicant: VMware, Inc., Palo Alto, CA (US)

(72) Inventors: Venkata Padma KAKI, West Godavari (IN); Rahul SINGH, Varnasai (IN); Padmini Sampige THIRUMALACHAR, Bangalore (IN); Abhishek SINGH, Bangalore (IN); Atreyee BHADURI, Bangalore (IN)

(73) Assignee: VMware, Inc., Palo Alto, CA (US)

(21) Appl. No.: 17/680,060

(22) Filed: Feb. 24, 2022

(51) Int. Cl. H04L 67/56; H04L 67/10

(52) U.S. Cl. CPC H04L 67/28; H04L 67/10

(57) ABSTRACT

The present invention is that of an application management system. This application management system contains at least one application, and at least one monitoring agent configured to monitor at least one of the applications. The monitoring agent is further configured to collect data from the application (or applications) it is monitoring. A helper script configured to receive data from the monitoring agent and convert the data into a new data format is also included in the system. The helper script will send the data in its new format to at least one cloud proxy, which will then send the newly formatted data to an adapter.

### BACKGROUND ART

Metrics allow a user insight on the operations and status of a system in question. The system in question may be an application running on a virtual machine. VMware has monitoring solutions available that assist a user in managing the large number of metrics, data, and applications.

One issue users often run into occurs when they wish to use a custom monitoring agent that is not VMware's custom Telegraph agent. In this case, the data format used by the custom monitoring agent may not be compatible with the application remote collector. In such cases, there is a need for a method to allow metrics from custom monitoring agents to be utilized by the existing system.

### BRIEF DESCRIPTION OF THE DRAWINGS

The accompanying drawings, which are incorporated in and form a part of this specification, illustrate embodiments of the present technology and, together with the description, serve to explain the principles of the present technology.

FIG. 1 is a flow chart of the pre-existing application monitoring system

FIG. 2 is a flow chart of the proposed application monitoring system

FIG. 3 shows a diagram of the system and the operation steps

FIG. 4 shows an architecture overview of the system

FIG. 5 shows a first relation that is a Managed VM object hierarchy

FIG. 6 shows a second relation that is an unmanaged VM object hierarchy

FIG. 7 shows a diagram of the process to use third party monitoring agents

### DETAILED DESCRIPTION OF THE EMBODIMENTS

Metrics allow an end user to have insight on the state, behavior, value, or changes of a particular system or subsystem that is recognized by the metric name. There are many components that generate metrics, and there are different systems and tools that may receive the metrics and visually display them in a graphical format for better understanding on the user's part.

vROps based Application Monitoring solution consumes the metric data generated by Telegraf and gives insight to the user about the status of their application. This system allows a user to monitor their Applications state and can take preventive actions when required. This ability to take preventative action could assist in avoiding downtime of critical Applications that perform day to day activities.

Current vROps based application monitoring is not a highly available solution, meaning there are multiple components in the data path between Telegraf and vROps that could be a point of failure. The current design can also only support up to a maximum of 3000 virtual machines from a VCenter. If a customer has a VCenter with more than 3000 hosts, they would be forced to choose only the most important machines hosting their applications for monitoring or even restrict the monitored virtual machines to 3000 hosts.

AppOSAdapter is an adapter based component of vROps and runs part of a Collector Service in the Cloud Proxy. This component currently has a one-to-one relation with the configured VCenter in vROps, meaning there could be only one AppOSAdapter created in a Cloud Proxy for any given VCenter. This point acts as a bottleneck which restricts scaling the system out horizontally, which would allow for more hosts to be monitored. The first step in the process of making the system horizontally scalable is to make the AppOSAdapter stateless so it can be installed on multiple Collectors. Having multiple instances of AppOSAdapter creates redundant components which would assist in making a high availability setup.

A high availability setup for application monitoring will be created using KeepaliveD, which provides a floating or virtual IP. Load balancing is achieved through HAProxy. KeepaliveD switches the virtual IP to the next available backup node upon failure of HAProxy or itself. Meanwhile HAProxy takes care of any failure that occurs with HTTPD-South or with AppOSAdapter running part of the collector service. In this way all the components (AppOSAdapter, HTTPD-South, HAProxy and KeepaliveD) involved in the data path can be made resilient to failures.

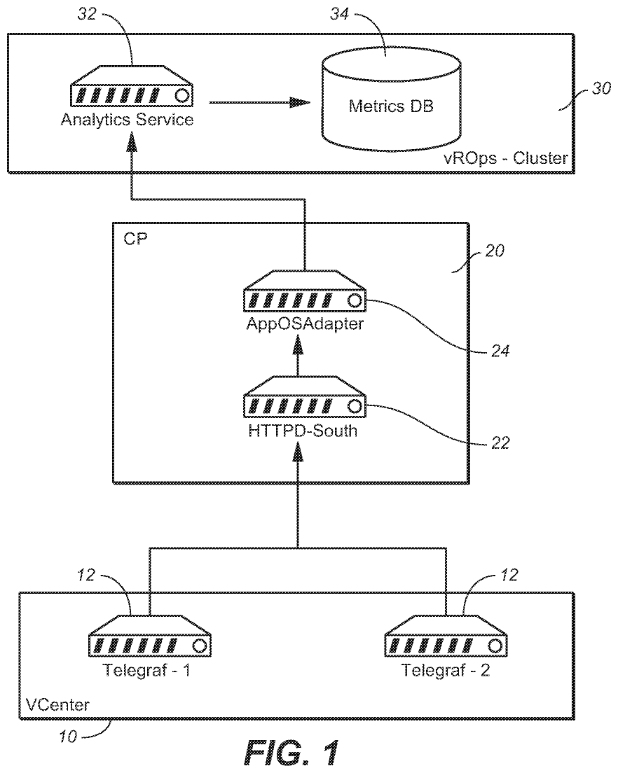

With reference now to FIG. 1, a flow chart of the pre-existing application monitoring system can be seen. In this schematic that shows the application monitoring flow, it can be seen that there is a VCenter 10 containing multiple instances of Telegraf 12, a single Cloud Proxy 20 that contains an AppOSAdapter 24 and a HTTPD-South 22, and a vROps Cluster 30 that contains an Analytics Service 32 and Metrics DB 34. The main issue with this design is within the Cloud Proxy 20, and the single instances of AppOSAdapter 24 and a HTTPD-South 22. should either of AppOSAdapter 24 and a HTTPD-South 22 fail, the whole system would be paralyzed. As such, AppOSAdapter 24 and a HTTPD-South 22 are two potential single points of failure.

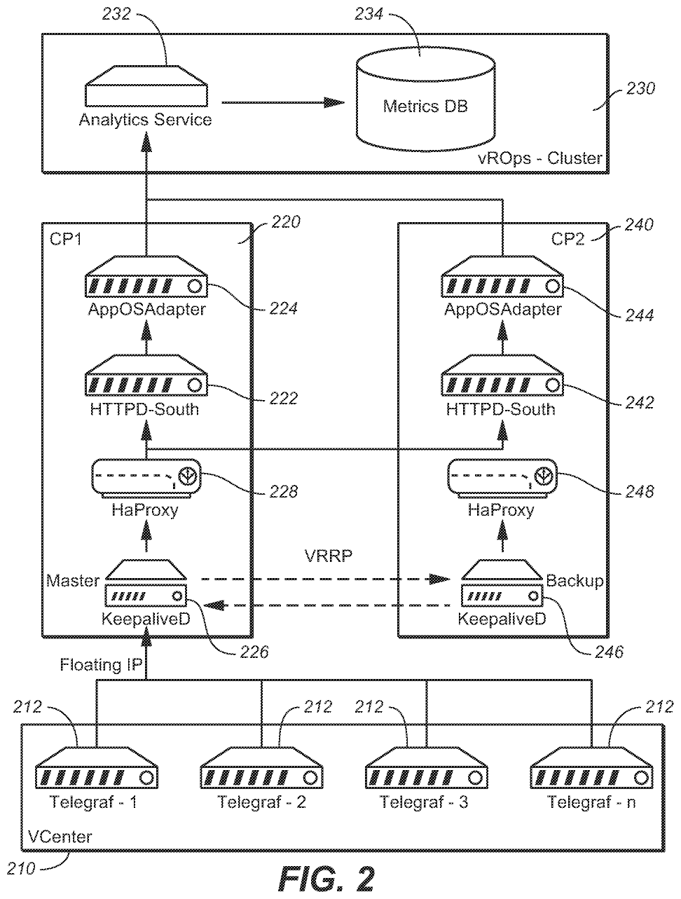

FIG. 2 shows a flow chart of the proposed application monitoring system as described in the current embodiment. In this embodiment, there is a VCenter 210 with one or more instances of Telegraf 212, which each may run multiple applications. The present embodiment also includes a receiving vROps Cluster 230, within which an Analytics Service 232 and Metrics DB 234 are included. The last portion of this embodiment are a first Cloud Proxy 220 and a second Cloud Proxy 240. The first Cloud Proxy 220 includes: a KeepaliveD 226, a HAProxy 228, a HTTPD-South 222, and an AppOSAdapter 224. Similarly, the second Cloud Proxy 240 includes: a second KeepaliveD 246, a HAProxy 248, a HTTPD-South 242, and an AppOSAdapter 244.

While two cloud proxies are shown in this embodiment, it should be appreciated that this design allows for more cloud proxies to be added according to the end user's needs. The cloud proxies act as an intermediary component. The ability of the end user to add on more cloud proxies allows the user to horizontally scale their setup to allow for as few or as many applications to be run and tracked as they require.

In the current embodiment, the one or more cloud proxies such as 220 and 240 may be added to a collector group. The collector group is a virtual entity or a wrapper on top of the cloud proxies 220 and 240 made to group them. With this embodiment, the multiple cloud proxies would offer alternative routes such that the failure of the services in the data plane would be less likely.

KeepaliveD 226 serves the purpose of exposing a virtual IP to the downstream endpoint nodes. In this embodiment Telegraf 212, the application metric collection service, would send the collected metric data to the Cloud Proxy 220 by utilizing KeepaliveD 226 and the virtual IP. Along with pushing the metric data from Telegraf 212 through the virtual IP, KeepaliveD 226 also communicates with second KeepaliveD 246 from the second Cloud Proxy 240. Through this communication, KeepaliveD 226 and second KeepaliveD 246 work in a master-backup format with KeepaliveD 226 as the master and second KeepaliveD 246 as the backup. Should any part of Cloud Proxy 220 fail, whether it be KeepaliveD 226 or an upstream component such as HAProxy 228, then KeepaliveD 226 will shift the virtual IP to the next available Cloud Proxy (in this case second Cloud Proxy 240). It should be appreciated that any other cloud proxies attached to the system may be included in the master-backup format and could potentially take on the equivalent master roll in case of the original master failing.

HAProxy 228 serves to preform load balancing actions, as well as handle any failures upstream of itself. More specifically, as HAProxy 228 receives metric data from KeepaliveD 226 it will then distribute the metric data to the available HTTPD-South instances (in the described embodiment the HTTPD-South instances would be 222 and 242, but it should be appreciated that more may be added at the user's discretion as more cloud proxies are added).

In this embodiment, a round robin distribution method is used, however other suitable distribution methods may also apply. By distributing the metric data with HAProxy 228 to the available HTTPD-South server instances 222 and 242, all the metric data received from Telegraf 212 would be equally distributed among the available AppOSAdapter instances 224 and 244 for processing. With this method, the system is horizontally scalable for the purpose of Application Monitoring.

Should HTTPD-South 222 or AppOSAdapter 224 fail, HAProxy 228 would then engage in its second function of rerouting requests to the next available HTTPD-South server instance (242).

In this embodiment, AppOSAdapter 224 is now a part of Cloud Proxy 220 (and AppOSAdapter 244 is now a part of second Cloud Proxy 240) instead of AppOSAdapter 224 being a part of a collector group, like the pre-existing design. This setup allows for multiple instances for a VCenter 210 to handle any failure. Each instance of AppOSAdapter (224, 244) will also have the VCenter 210 information to which it would be attached.

Due to the load balancing method that HAProxy 228 uses, metric data could arrive on any instance of AppOSAdapter (224, 244) running as part of the collector group. As a result, AppOSAdapter 224 and 244 need to be stateless to handle such metric data. Cache within AppOSAdapter 224 and 244 maintains information about the metrics related to the object it has processed for 5 consecutive collection cycles. In the case that there is no metric for an object processed by AppOSAdapter (224 for example), it is marked as “Data not Receiving”. This label could create confusion for the person who is viewing this specific object as the metrics are still being received, but by a new AppOSAdapter (244 in this example). The same issue would show up while showing the errored object. We ended up showing as Collecting as we collect one metric related to the availability of the object as unavailable. But with respect to the object, there is still a metric being processed.

To reduce confusion, the current embodiment may employ a priority based list of status. All statuses of “error” would have the highest display priority followed by all the “collecting” statuses. All others would have subsequent priority. Using this priority list, the objects of interest may be displayed in terms of highest to lowest priority for ease of the user. It should be appreciated that other display methods such as lowest to highest priority, a user dictated arrangement, or similar arrangements may also be utilized.

Application remote collector (ARC) is a component native to vRealize Operations Suite (vROps). In an on-premises environment ARC does Application monitoring with the help of a custom Telegraf agent to ensure that software applications maintain the level of performance needed to support business outcomes. In SaaS, the same purpose is achieved by a component called Cloud Proxy (CP).

CP can monitor two different kinds of endpoints: the first being the endpoint for which the vCenter is being monitored in vROps, and the other is a physical or non-monitored vCenter (VC) endpoint. In the former case the metrics will be handled by the ARC adapter, and the latter will be handled by the Physical Adapter in the CP. Both the adapters will accept metrics only in ‘Wavefront’ format.

There are four major limitations with the current approach. The first limitation is that the custom Telegraf agent is the only supported agent if the user wants to use the ARC component. If the user is utilizing some other monitoring agent and intends to bring in data through the ARC, they cannot leverage the existing functionality.

The second limitation is that the user can only monitor a certain number of plugins or applications that are supported by the ARC. These plugins or applications must also be well defined, and their Telegraf agent plugin configuration must be completely owned by the ARC. This requirement is because of the current parser framework implemented in the ARC adapter.

The third limitation is that the user cannot bring additional metrics into CP for the curated plugins.

Finally, the relationship from vSphere to the virtual machine and applications is the most important additional value that vROps brings in. However, the fourth limitation is that if any agent other than custom Telegraf is used, the user is required to build the relationship from vSphere to the very low application, a process that cannot be done automatically.

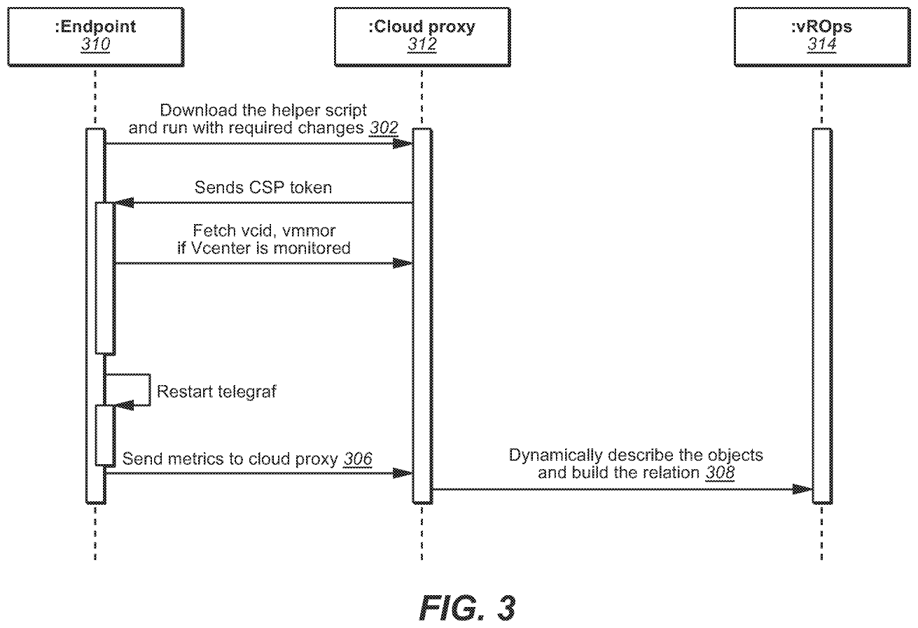

FIG. 3 shows a diagram of the system and the operation steps as described in the present embodiment. The current invention overcomes these limitations as described herein. The system includes an endpoint 310, which may refer to the combination of monitoring agents and the applications being run, a cloud proxy 312, and vROps 314.

Firstly, the user is now free to choose any monitoring agent they want. Next, the user can download the helper script (shown by arrow 302) which can be hosted in cloud proxy 312. This helper script allows the user to make modifications to the data and send the data in wavefront format to the cloud proxy 312 (as shown by arrow 306).

Next, there is no longer a limitation on the types of application the user can bring in. With the help of the “Generic application parser framework” implemented in the ARC adapter (which is part of vROps 314), all types of application metrics can be processed, and the objects are “dynamically created” with no need for the user to provide any static definition for the resources (as shown by arrow 308). The user can also bring in additional metrics for the curated plugins, as well with the support of the Generic parser framework.

Finally, the relationship between vSphere (part of vROps 314) and the very low application (part of endpoint 310) may be automatically built at the adapter side. If the identity of the parent object is provided, for example VCID and VMMOR are the identifier for the host and can be retrieved from the VCenter itself, then the relationship is built from the application to vSphere world. Otherwise, based on UUID of the endpoint the relation would is built from the Operating system world to the Application.

The proposed solution does require that the user sends their data to the cloud proxy 312 in Wavefront format. The user can convert their data to Wavefront format by making use of the downloadable helper scripts, or the user is free to convert the data from any other formats such as influx, JSON, CSV, etc, into wavefront format and then send the metrics to the cloud proxy 312.

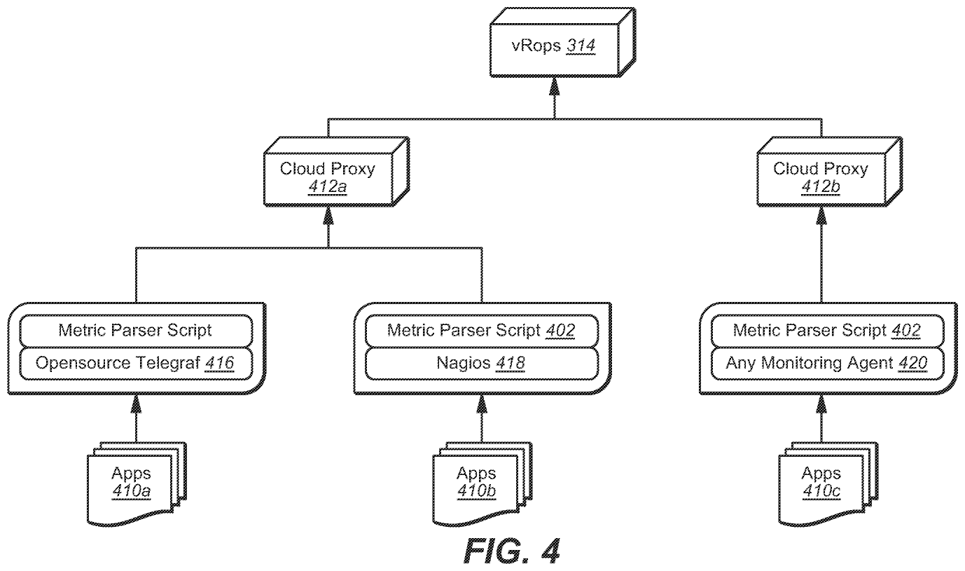

FIG. 4 shows an architecture overview of the system as described in the current embodiment. Here, it can be seen that the user may include multiple cloud proxies (412a and 412b) in the system. Multiple monitoring agents may also be used in the same instance of cloud proxy 312. Instead, the user may choose to use Telegraf 416 to monitor one set of applications 410a, Naigos 418 to monitor a second set of applications 410b, or another third-party monitoring agent 420 to monitor a third set of applications 410c. it should be appreciated that the arrangement of monitoring agents 416, 418, and 420 may vary from that of FIG. 4, and the number of cloud proxies is allowed to vary.

In order for the user to upload their data to the cloud proxy 412a or 412b in Wavefront format, the first thing they should do is to download the helper script 402 hosted in cloud proxy 412a or 412b. The user must then run the helper script 402 with the required arguments and Metadata to parse the input metrics, which will help in processing the input metrics and using them to select the required fields. The script 402 will then convert the metrics into Wavefront format and will post the metrics to the Physical Adapter running on the cloud proxy 412a or 412b.

To help illustrate this process, sample data from one of the agents, in this case Nagios 418, would look like:

```
DATATYPE::SERVICEPERFDATA  TIMET::1602071160 IP::127.0.0.1
    HOSTNAME::Centos-linus-endpoint SERVICEDESC::Total Processes
                SERVICEPERFDATA::procs=124;400;500;0;
      SERVICECHECKCOMMAND::check_local_procs!400!500!RSZDT
      HOSTSTATE::UP  HOSTSTATETYPE::HARD SERVICESTATE::OK
                      SERVICESTATETYPE::HARD′
```

In this case the meta data would take the form of <plugin-name,hostname, value-filed, Unique-identifier> which would look like:
<SERVICEDESC,HOSTNAME,SERVICEPERFDATA>

The correcting input data would then take the form of:
<Total Processes, Centos-linux-endpoint,124>

Once the data is converted to Wavefront it would look like:
data=total.processes.procs 124 1602071160 source=localhost
VCID=5b10cc65-4413-4601-827a-8b427da637bd VMID=vm-189

The script will then make a suite API call to vROps 314 to get VCID and VMID details in case the endpoint vCenter is being monitored in vROps 314. Otherwise, the script will generate UUID for the endpoint.

Lastly, there is a generic metric filtering logic implemented at the ARC/Physical adapter end which will identify the applications and dynamically creates objects for them in vROps 314. The objects created in vROps 314 will take either one of two relations in the UI.

FIG. 5 shows a first relation that is a Managed VM object hierarchy, where if a vCenter Server of the VM is monitored by vRealize Operations Cloud, then the operating system and application objects fall under the respective VM>OS object>‘application service’ instance.

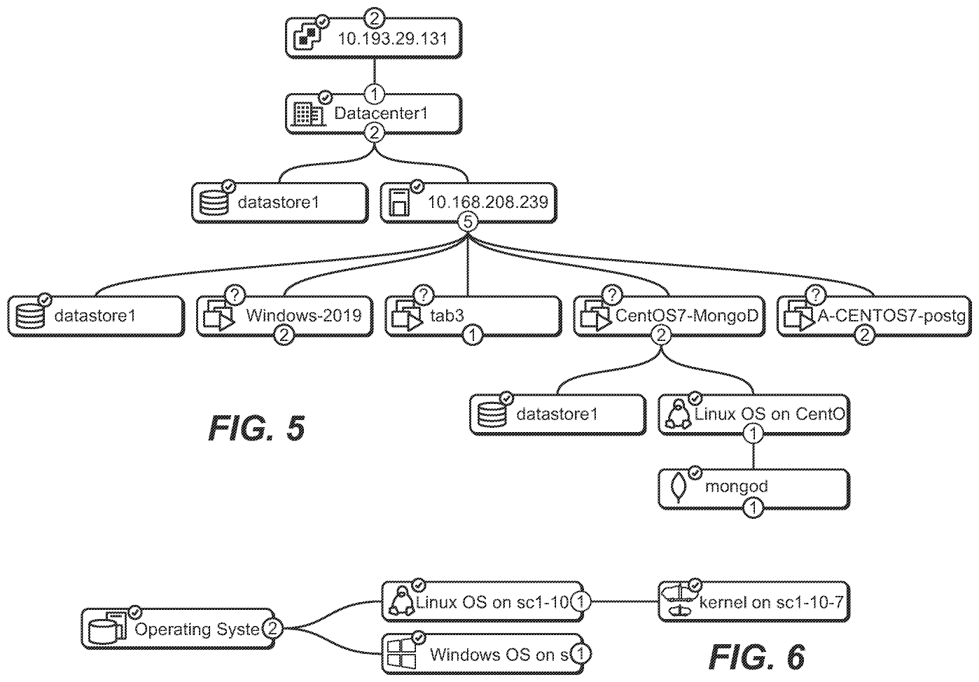

FIG. 6 shows a second relation that is an unmanaged VM object hierarchy, where if a vCenter Server of the VM is not monitored by vRealize Operations Cloud then the operating system and application objects fall under the Environment>Operating System World>OS object>‘application service’ instance.

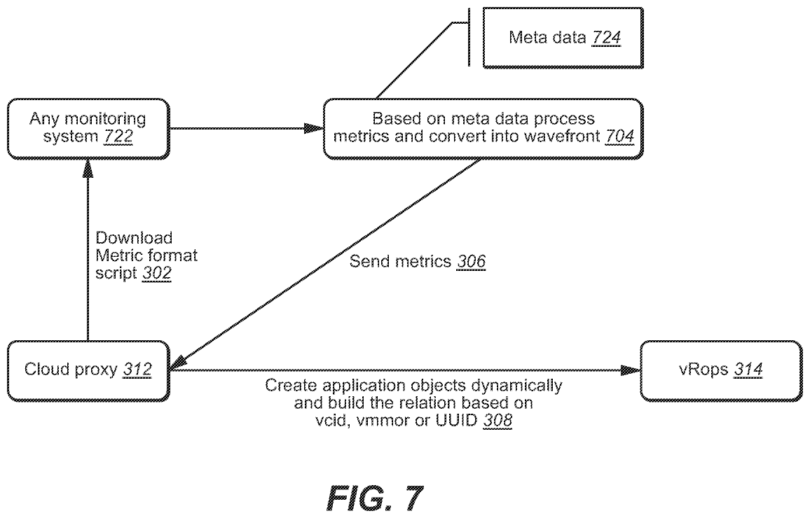

FIG. 7 shows a diagram of the process to use third party monitoring agents as described by the current embodiment. In this instance, the user is making use of any third party monitoring system or agent 722. First, the user will download a metric formatting script (arrow 302) from the cloud proxy 312. Meta data 724 will be supplied from one or more applications (shown in FIG. 4) to the metric formatting script, which will convert the meta data 724 into a format that the cloud proxy 312 and vROps 314 can utilize (as shown by step 704). The formatted meta data 724 will then be sent to the cloud proxy 312 (or to whichever instance the monitoring agent is in communication with, in the case of multiple cloud proxies) as shown by arrow 306. Cloud proxy 312 will then forward the formatted meta data to vROps 314. vROps 314 may then proceed to create application objects as required, and dynamically build relationships as shown by arrow 308.

The previously existing solution works only with the Telegraf 416 agent and there is no way to send additional metrics that are application metrics other than those already defined. The current embodiment is a generic way where the user can convert from any data format to wavefront format, and the Application discovery adapter will have the capability to dynamically describe these objects with no describe .xml changes required. This new method could address all the issues previously mentioned at the beginning of the present disclosure, and this method it can be leveraged for any monitoring agent.

The freedom to choose an agent and get any desired metric and still use a platform like vROps 314 to do all other Event management is a Nirvana. And to top with all the advantages of relationship from the very top to drill down to the application level is a step above other current processes.

What we claim is:

1. An application management system comprising:
A host with at least one application;
at least one monitoring agent configured to monitor at least one of said application, and further configured to collect data from said application;
a helper script configured to receive said data from said monitoring agent and convert said data into a new data format;
at least one cloud proxy configured to receive said new data format from said helper script; and
an adapter configured to receive said new data format from said proxy.

2. The application system of claim 1 wherein, said helper script converts said data to a wavefront format.

3. The application system of claim 1 wherein, if said host is being monitored then said adapter will manage said new data.

4. The application system of claim 1 wherein, if said host is not being monitored then a physical adapter in said cloud proxy will manage said new data.

5. The application system of claim 1 wherein, said adapter can discover a new application and create a relation with said new application.

6. The application system of claim 1 wherein, said helper script allows a previously incompatible data format to function within the system by converting said data to said new data.

7. The application system of claim 1 wherein, said agent will authenticate itself with said cloud proxy.

8. The application system of claim 1 wherein, said adapter in said cloud proxy will have a generic data parser and a dynamic object builder which will dynamically create said application.

9. The application system of claim 1 wherein, said adapter in said cloud proxy will build a relation from said host to a parent if said host is monitored.

10. The application system of claim 1 wherein, said adapter has no limitations on a number of provided metrics within the system sizing guidelines.

11. An application management system comprising:
A host with at least one application;
a monitoring agent configured to monitor at least one of said application, and further configured to collect data from said application;
a helper script configured to receive said data from said monitoring agent and convert said data into a new data format such that said helper script allows a previously incompatible data format to function within the system;
at least one cloud proxy configured to receive said new data format from said helper script; and
an adapter configured to receive said new data format from said proxy, wherein said adapter can discover a new application and create a relation with said new application.

12. The application system of claim 9 wherein, said helper script converts said data to a wavefront format.

13. The application system of claim 9 wherein, if said host is being monitored then said adapter will manage said new data.

14. The application system of claim 9 wherein, if said host is not being monitored then a physical adapter in said cloud proxy will manage said new data.

15. The application system of claim 9 wherein, said agent will authenticate itself with said cloud proxy.

16. An application management system comprising:
A host with at least one application;
a monitoring agent configured to monitor at least one of said application, and further configured to collect data from said application;
a helper script configured to receive said data from said monitoring agent and convert said data into a wavefront data format such that said helper script allows a previously incompatible data format to function within the system;
at least one cloud proxy configured to receive said wavefront data from said helper script; and
an adapter configured to receive said wavefront data from said proxy, wherein said adapter can discover a new application and create a relation with said new application.

17. The application system of claim 15 wherein, if said host is being monitored then said adapter will manage said wavefront data.

18. The application system of claim 15 wherein, if said host is not being monitored then a physical adapter in said cloud proxy will manage said wavefront data.

19. The application system of claim 15 wherein, said agent will authenticate itself with said cloud proxy.
